(19) United States
(12) Patent Application Publication
(10) Pub. No.: US 2008/0220181 A1
(43) Pub. Date: Sep. 11, 2008

(54) Method of loading a nanotube structure and loaded nanotube structure

(75) Inventors: Nadarajan S. Babu, Philadelphia, PA (US); Elisabeth S. Papazoglou, Yardley, PA (US); Peter D. Katsikis, Merion Station, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Philadelphia Health & Education Corporation, d/b/a Drexel University College of Medicine, Philadelphia, PA (US)

(21) Appl. No.: 11/895,370

(22) Filed: Aug. 24, 2007

Related U.S. Application Data
(60) Provisional application No. 60/840,015, filed on Aug. 25, 2006.

(51) Int. Cl. B05D 7/22; B05D 3/06

(52) U.S. Cl. 427/551; 427/235; 427/232; 427/230; 427/553; 977/744

(57) ABSTRACT

Nanotubes loaded with materials, such as active species, and methods to load materials into nanotubes are disclosed. The method includes flowing a medium containing the material to be loaded through the interior volume of the nanotube, wherein it is retained, optionally by a crosslinking or polymerization reaction. Flowing the medium occurs under different conditions and processes, including centrifuging and size exclusion methods.

### CROSS REFERENCE TO RELATED APPLICATIONS

This application claims the benefit pursuant to 35 U.S.C. §119(e) to U.S. provisional patent application 60/840,015, which was filed on Aug. 25, 2006 and which is incorporated herein by reference in its entirety.

### FIELD

The present disclosure relates to nanotube materials. More particularly, the present disclosure relates to methods of loading material into a nanotube structure and also the loaded nanotube structure.

### BACKGROUND

In the discussion of the background that follows, reference is made to certain structures and/or methods. However, the following references should not be construed as an admission that these structures and/or methods constitute prior art. Applicant expressly reserves the right to demonstrate that such structures and/or methods do not qualify as prior art.

Nanotubes, particular carbon nanotubes (CNTs), have been investigated for several applications, including electronic applications (see, for example, U.S. Pat. Nos. RE 38,561, RE 38,223 and 5,773,921) and biologic applications (see, for example, Pantarotto et al., Chemical Communications, 16-17, 2004; Lu et al., Nano Lett., 4:2473-2477, 2004; ShiKam et al., J. Amer. Chem. Soc., 126:6850-6851, 2004; ShiKam et al., PNAS, 102:11600-11605, 2005; Naguib et al., Nanotechnology, 567-571, 2005; and Salvador-Morales et al., Mol. Immunol., 43-193-201, 2006.). Typically, at least in the biological applications, the material of interest added to the nanotube has been associated with the exterior surface of the nanotube, such as through a functionalization technique (see, fore example, Pantarotto et al., Chem. Biol., 10:961-966, 2003.). Carbon nanotubes with magnetic particles (Korneva et al., Nano Letters, 5:879-884, 2005.) or fluorescent nanoparticles (Kim et al., Nano Letters, 5:873-878, 2005) in the interior have been shown, where the particles are in the interior by evaporation of the solvent resulting in precipitation of the particles along the walls of the nanotubes (Kim et al., Nano Letters, 5:873-878, 2005.) or by condensation of aqueous solutions (Babu et al., Microfluidics and Nanofluidics, 1:284-288, 2005; Rossi et al., Nano Letters, 4:989-993, 2004). On the other hand, capillary action has been utilized to load CNT with liquids containing magnetic particles however this method cannot be used to fill with fluids of viscosity higher than water. However, loading nanotubes with fluids that are more viscous than water has only been demonstrated by the hydrothermal process (see, Gogotsi, Y. et al., In situ chemical experiments in carbon nanotubes, Chemical Physics Letters, vol. 365 (3, 4), pp. 354-360, 2002.), which requires very high pressures and temperatures rendering it impractical for most applications. Especially in biological application this method is prohibitive due to the sensitivity of biological samples to temperature and pressure.

The disclosure of co-pending U.S. application Ser. No. 11/327,674, filed on Jan. 5, 2006, is incorporated herein in its entirety.

### SUMMARY OF THE INVENTION

An exemplary method of loading nanotube structures comprises moving a loading solution through an interior region of a nanotube structure, wherein the loading solution includes a material to be loaded into the nanotube structure and wherein the material to be loaded is retained in at least a portion of the interior region of the nanotube structure as the loading solution is moved through the interior region, removing excess of the loading solution from the loaded nanotube structure, and collecting the suspended loaded nanotube structures.

An exemplary method of loading a polymerizable medium into a nanotube structure comprises suspending a number of nanotube structures in an initial suspension liquid, placing a washing liquid containing the suspension of nanotube structures on top of a loading solution, the loading solution including a material to be loaded into the nanotube structure, wherein the loading solution can have a viscosity higher than the washing liquid, centrifuging the washing liquid and the loading solution to move at least a portion of the nanotube structures from the washing solution into the loading solution, recovering at least a portion of the nanotube structures from the loading solution and washing the nanotubes once or more times by resuspending the recovered nanotube structures in a crosslinking liquid, adding a polymerization agent or crosslinking agent to the suspension, and collecting the loaded nanotube structures.

Another exemplary method of loading a polymerizable medium into a nanotube structure comprises suspending nanotube structures in an initial suspension liquid, placing the initial suspension liquid containing the suspension of nanotube structures on top of a loading liquid in a container, the loading liquid including a material to be loaded into the nanotube structure, wherein the loading liquid has a higher or lower viscosity than the initial suspension liquid, centrifuging the container to move at least a portion of the nanotube structures from the initial suspension liquid into the loading liquid, recovering at least a portion of the nanotube structures from the loading liquid, transferring the recovered nanotube structures to a washing liquid and creating a suspension of the recovered nanotube structures, polymerizing or crosslinking the material loaded in an interior region of the nanotube structure, and separating the polymerized or crosslinked loaded nanotube structures from the suspension.

An exemplary method of loading nanotube structures comprises counterflowing a liquid to be loaded and the nanotube structure, wherein the liquid to be loaded travels in an opposite direction relative to the nanotubes structures.

An exemplary method of orienting and aligning loaded nanotubes in a polymerizable liquid comprises aligning or orienting loaded nanotubes in a polymerizable medium by centrifugal force, electric field or magnetic field, and initiating polymerization, wherein the loaded nanotubes are immobilized for a particular application.

It is to be understood that both the foregoing general description and the following detailed description are exemplary and explanatory and are intended to provide further explanation of the invention as claimed.

### BRIEF DESCRIPTION OF THE DRAWING

The following detailed description can be read in connection with the accompanying drawings in which like numerals designate like elements and in which:

FIG. 1 shows a cross section of a typical nanotube structure synthesized using the methods described herein.

FIG. 2 schematically illustrates a process to synthesize nanotube structures of carbon.

FIG. 3 illustrates an exemplary method of loading a nanotube structure that comprises flowing a first liquid medium through an interior region of a nanotube structure by centrifuging.

FIG. 4 illustrates another exemplary method of loading a nanotube structure that comprises flowing the first liquid medium through an interior region of the nanotube structure by filtration with pressure and/or vacuum.

FIG. 5 illustrates a further exemplary method of loading a nanotube structure that comprises forcing a liquid medium through a fluidized bed containing the nanotube structure under a pressure and at a temperature.

FIG. 6 illustrates a schematic cross-sectional view of a nanotube structure containing the material to be loaded.

FIG. 7 illustrates a schematic cross-sectional view of a nanotube structure containing the material to be loaded that has been subject to a polymerization step.

FIG. 8 is an image of collected nanotube structures on membranes according to Example 3.

### DETAILED DESCRIPTION

The term “nanotube structure” as used herein refers to a structure having an aspect ratio of larger than one, having a cross section of any shape (circular, ellipsoid, polygonal, rectangular, or other regular or irregular shape), wherein one dimension is of the order of 100 nm or less, but can be up to 1000 nm, and any and all whole or partial integers there between. One, non-limiting example of a nanotube structure is a carbon nanotube or CNT, which may be single-walled (SWNT), double-walled (DWNT) or multi-walled (MWNT) in form.

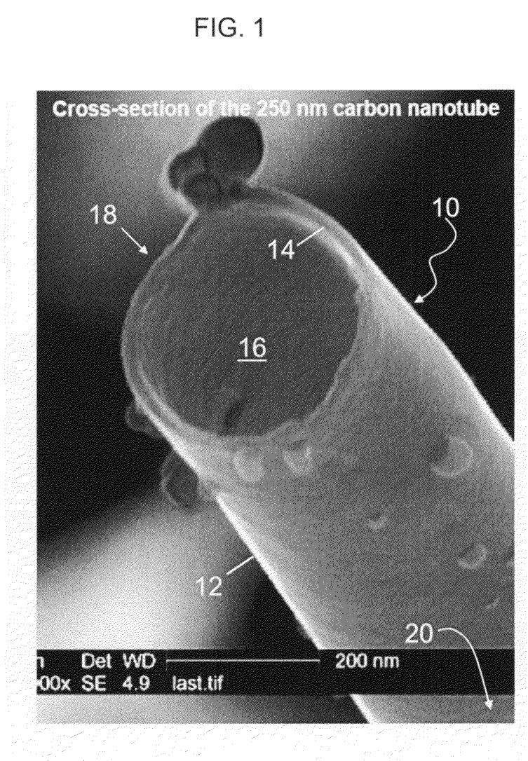

FIG. 1 shows a cross section of a typical nanotube structure. The nanotube structure 10 in FIG. 1 is generally cylindrical, at least over short length distances, and has an outer periphery 12 and an inner surface 14 that bounds an interior volume 16. The interior volume 16 generally extends from a first end 18 to a second end 20 and has an axis of orientation oriented radially centrally from the first end 18 to the second end 20. Both the first end 18 and the second end 20 are open, e.g., are not capped as is known in the nanotube art, establishing a central bore or tube of the nanotube structure.

Nanotube structures suitable for use in the disclosed methods may be formed by any suitable technique. For example, it is possible to synthesize nanotube structures of carbon of various diameters (50-250 nm) (see, for example, Microfluidics and Nanofluidics, 1:284-288, 2005; Rossi et al., Nano Letters, 4:989-993, 2004.). Templates for the synthesis of nanotube structures having larger diameters (250 nm) are commercially available. One type of nanotube structures that is preferred in the present application is known as a multi-wall nanotube (MWNT), although this type of nanotube structures lacks the proper crystalline structure normally found in nanotube structures synthesized using a metal catalyzed Chemical Vapor Deposition (CVD) process.

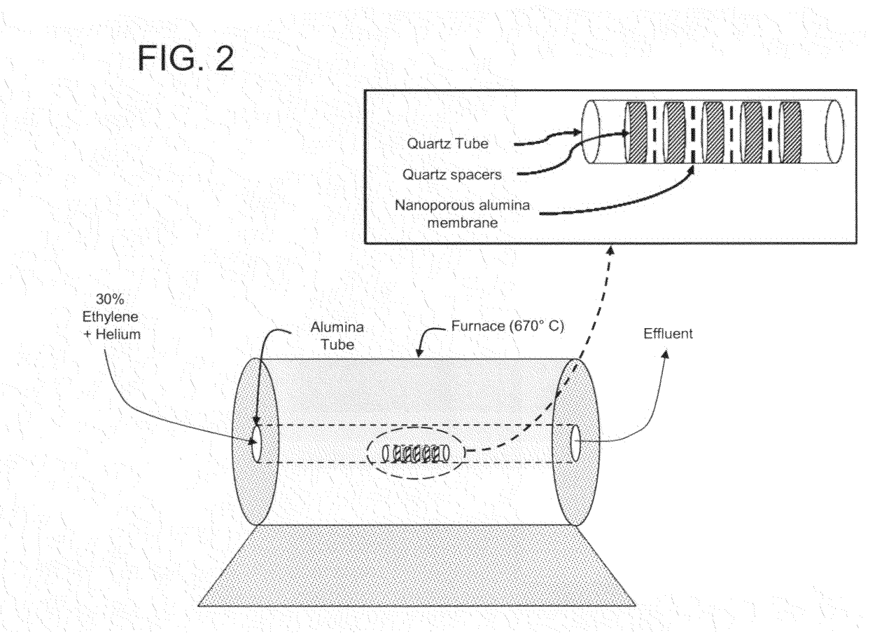

Here, nanotube structures of carbon were synthesized by following the template assisted method established by Miller et al. (Miller et al., J. Amer. Chem. Soc., 123:12335-12342, 2001.). In brief, an alumina membrane (Whatman Anodisc 13 mm diameter, and a 250 nm pore size) placed in a quartz reaction vessel acts as the template for the carbon nanotubes to grow. A tube furnace capable of reaching at least 1000° C. was used to crack a mixture of ethylene and argon gas flowing at a rate of 20 sccm over the alumina membrane. The decomposition of ethylene gas at 670° C. resulted in deposition of carbon around the inner walls of the alumina membrane; the thickness of the deposited carbon layer thus depends on the process time. For the intended purpose, a reaction time of 6 hours was adequate, but various times can be selected depending on a desired thickness. The layer of carbon on the sides of the membrane was removed using mild sonication (47 kHz, bath sonicator). The membranes with carbon nanotubes were completely soaked in 6M NaOH for at least twelve hours to completely remove the template. The nanotubes were removed from the suspension after template removal by filtering though polycarbonate membrane filters with 1 micron pores (SPI Supplies). A schematic representation of the process is shown in FIG. 2.

It is generally difficult to place a material in the interior region of the nanotube structure, as the interior has a small diameter (on the order of 100 nm or less but can be up to 1 micron) that presents capillary force barriers to the entry of liquid media. As the viscosity of liquid media is increased, typically this barrier is also increased.

Loading of a material into the interior region of a nanotube structure can be by any of several methods. An exemplary method of loading a nanotube structure comprises flowing a first liquid medium through an interior region of the nanotube structure, wherein the first liquid medium includes a material to be loaded into the nanotube structure and wherein the material to be loaded is retained in at least a portion of the interior region.

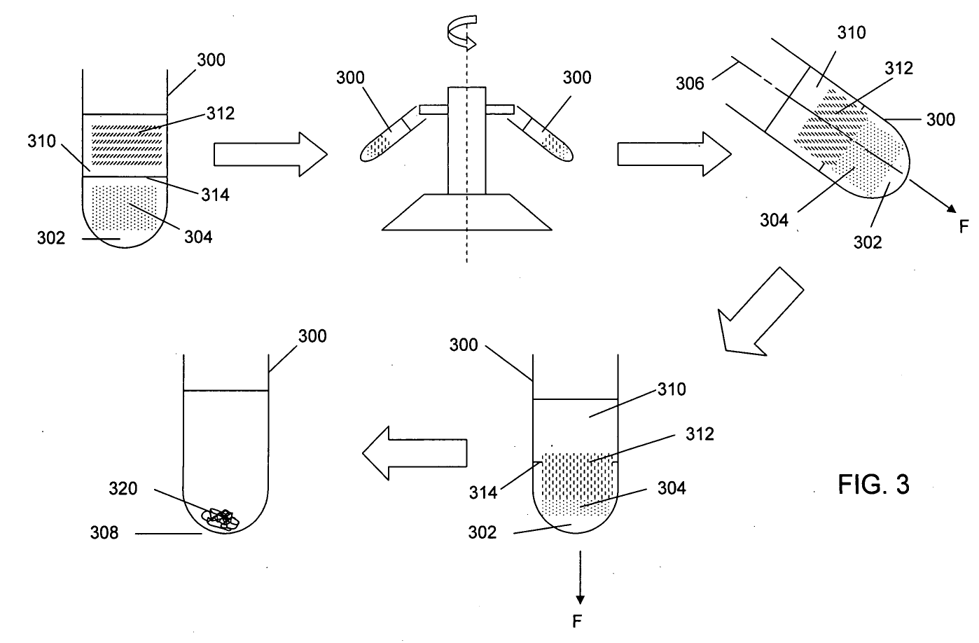

An example of flowing the first liquid medium through the interior region of the nanotube structure includes centrifuging a mixture including the first liquid medium and the nanotube structure. FIG. 3 illustrates the exemplary method.

In the exemplary method depicted in FIG. 3, a centrifuge container 300, such as a tube, is loaded with a first liquid medium 302. The first liquid medium 302 contains the material to be loaded 304. For example, sodium alginate can be the first liquid medium. Other first liquid mediums can include crosslinkable polymers, via ionic crosslinking, heat, UV, or other appropriate catalysts, or high and medium MW materials of appropriate viscosity for loading. This includes mixtures of crosslinkable and non-crosslinkable materials, where the crosslinkable matter can provide “sealing” of the nanotube structure. Examples of the material to be loaded 304 can include active species, such as pharmacological species, catalytic species or sensory species, as well as monomeric, oligomeric and polymeric materials in catalytic polymerization that can act as source ingredients in a self-healing application. The first liquid medium 302 has a viscosity higher than water, e.g., a viscosity greater than 0.890±10−3 Pa·s at 25° C. and a standard pressure of 760 mm. Next, a second liquid medium 310 containing suspended nanotube structures 312 is added to the centrifuge container 300. An example second liquid medium is water. Because the first liquid medium and the second liquid medium have different viscosities and/or different viscoelastic properties, the first liquid medium is phase separated from the second liquid medium forming an interface 314.

The centrifuge container 300 with the mixture of first liquid medium 302 and nanotube structures 312 suspended in second liquid medium 310 is placed in the centrifuge and the centrifuge is started. Exemplary parameters for centrifuging include RCF=3220 xg (RCF=relative centrifugal force=11.18×r×(RPM/1000)², where r is the rotor radius in cm, time=30 to 45 minutes and temperature is 4° C.

In suspension, the nanotube structures 312 are randomly oriented. However, upon centrifuging the mixture, the nanotube structures 312 preferentially orient with their axis roughly parallel to the centrifugal force and perpendicular (within 30 degrees) to the axis 306 of the centrifuge container 300 and, under centrifugal forces F, move towards the distal end or bottom 308 of the centrifuge container 300. Other parameters that influence the orientation of the nanotube structures 312 include viscosity of the solution; interaction between the solution and the nanotube structures (for example, alignment of hydrophobic nanotubes in alginate is not favored); the relative viscosity between the suspension medium (second liquid medium 310) and the solution (first liquid medium 302); acceleration time; and size, surface charge, surface tension, friction coefficient and viscoelastic properties of the nanotube structures. Each of these parameters can be manipulated to influence the process of orienting the nanotube structures.

For example, where the relative viscosity between the suspension medium (second liquid medium 310) and the solution (first liquid medium 302) are different, e.g., the solution has a higher viscosity than the suspension medium, the first liquid medium and the second liquid medium phase separate to form an interface. The nanotube structures of the second liquid medium then passes through the interface 314, e.g., the alginate-water interface, during the centrifuging of the mixture. The preferential alignment of the nanotube axis in relation to the interface forces the first liquid medium into the interior volume of the nanotube structure. In other words, under the centrifuge forces, the nanotube structures pass through the interface, and the first liquid medium can overcome the capillary forces and enter into the interior volume. The first liquid medium is retained in the interior volume as the nanotube structures amass at the bottom of the centrifuge tube during centrifugation. In some instances, the nanotube structures can form a solid mass 320, such as a pellet, at the bottom 308 of the centrifuge container 300. The mass can be recovered and, optionally, broken into smaller pieces for subsequent use.

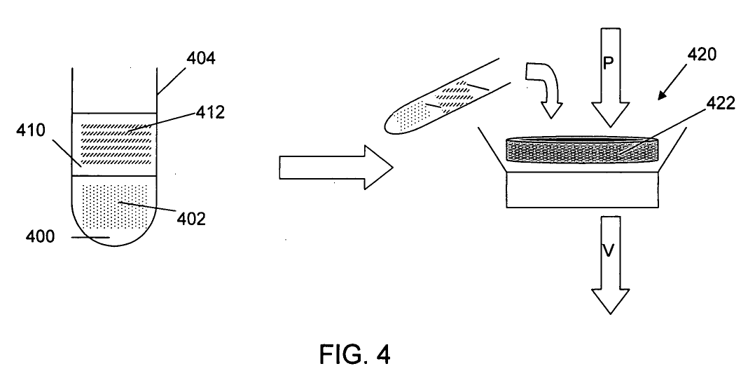

Another example of flowing the first liquid medium through the interior region of the nanotube structure includes adding a mixture including the first liquid medium and the nanotube structure to a first side of a filter and forcing the mixture through the filter, under one or more of pressure and vacuum, to separate the nanotube structure from the first liquid medium. FIG. 4 illustrates the exemplary method.

In the exemplary method of FIG. 4, a first liquid medium 400 containing the material to be loaded 402 is placed in a common volume 404, such as a tube or a beaker, with a second liquid medium 410 containing a suspension of nanotube structures 412, such as nanotube structures suspended in water. In optional embodiments, the nanotube structures may be suspended directly in the first liquid medium containing the material to be loaded. An example of a first liquid medium is an alginate, and an example of a second liquid medium is water. Other first and second liquid mediums can be used, such as organic solvents, PBS, culture media for first mediums and polymers, monomers, proteins, enzymes, viruses as second mediums. By washing with excess wash liquid (water, salt solution etc.), one can suspend the filled nanotubes and add crosslinking medium to polymerize the contents of the nanotube, while the nanotubes remain as individual tubes in suspension. Examples of the material to be loaded 402 can include active species, such as pharmacological species, catalytic species or sensory species, or high performance materials.

The nanotube structures 412, whether in a common liquid medium or in two or more liquid media, are placed in a filter 420. The filter 420 is then activated, either by drawing a vacuum V below the filter medium or by applying a pressure P above the filter medium, to drive the liquid medium through the filter 420. In this process, some of the material to be loaded is also driven through the interior volume of the nanotube structures and is retained in the interior volume after the filtration has occurred. The nanotube structures are generally retained by the filter medium 422. In an optional exemplary method, where separate liquid medium are used for the material to be loaded in the nanotube structure suspension, the two mediums may be mixed prior to the filtration process.

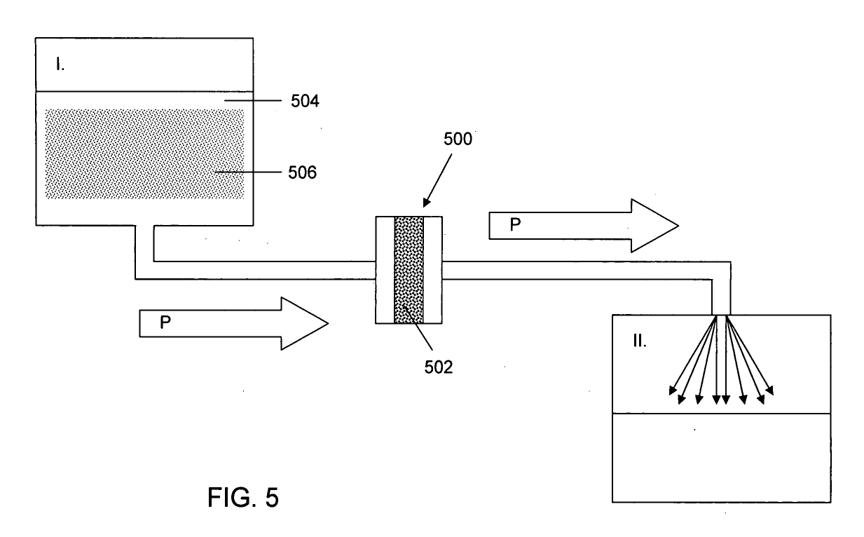

A further example of flowing the first liquid medium through the interior region of the nanotube structure includes forcing the first liquid medium through a fluidized bed containing the nanotube structure under a pressure and at a temperature. FIG. 5 illustrates the exemplary method.

In the exemplary method of FIG. 5, nanotube structures 502 are incorporated into a fluidized bed 500 by counterflow of nanotube in medium 1 and medium 2 or appropriate mixtures of the two. The fluidized bed 500 may then be placed in the flow path P of a liquid medium 504 containing the material to be loaded 506. An example of a liquid medium is alginate solution, and an example of a fluidized bed is carbon nanotubes. Other liquid medium and fluidized beds can be used, such as gelatin solution, collagen, chitosan, hyaluronic acid, other natural or synthetic polymeric solutions with appropriate solvents. Examples of the material to be loaded 506 can include active species, such as pharmacological species, biomolecules (bacteria, viruses, peptides, antibodies, proteins), catalytic species, sensory species, polymer solutions, oligomers, monomer solutions and colloidal solutions.

Under pressure and temperature, which may vary from standard temperature and pressure to temperatures and pressures associated with super critical fluids, the liquid medium 504 containing the material to be loaded 506 is flowed through the fluidized bed 500. At least a portion of the interior volume of the nanotube structure retains some of the material to be loaded. Subsequently, the fluidized bed may be removed from the flow path and the nanotube structures recovered, for example, by filtration, or other size exclusion method.

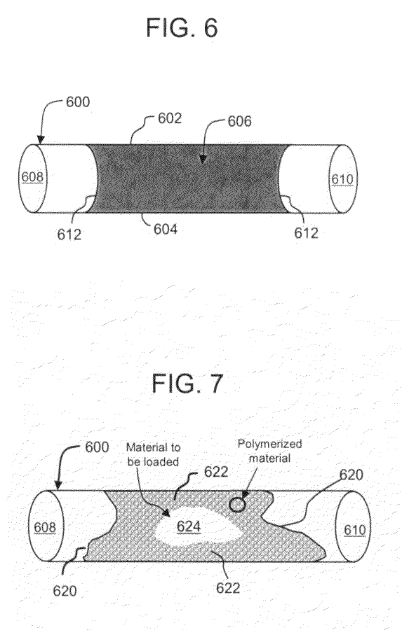

FIG. 6 illustrates a schematic cross-sectional view of a nanotube structure 600 containing the material to be loaded. The cross-sectional axial view shows a first nanotube structure wall 602 and a second nanotube structure wall 604. The material to be loaded 606 is between the first nanotube structure wall 602 and the second nanotube structure wall 604. The nanotube structure 600 is open at each of a first end 608 and a second end 610. At the first end 608 and the second end 610, the material to be loaded forms a meniscus 612, indicative of the capillary forces retaining the material within the interior volume.

In optional subsequent steps to loading the interior volume of the nanotube structure, the material loaded in the interior volume may be encapsulated by, for example, a polymerization step. As seen in FIG. 7, an exemplary polymerization step forms a polymerized wall 620, at least at the open first end 608 and open second end 610 of the loaded nanotube structure. Additionally, any diffusion of polymerizing or crosslinking agent through the nanotube structure wall may form a polymerized layer 622 at the interface of the loaded material in the inner surface of the nanotube structure. The interior region 624 of loaded material may remain unpolymerized. Examples of liquid medium that may be used in the disclosed exemplary methods, include, an alginate, a hydro gel, solution of sufficient viscosity or any crosslinkable polymer/oligomer, gelatin solution, any gel forming material, natural and synthetic oligomers and polymers and their derivatives, or other high molecular weight material.

Once the nanotube structures are loaded, the loaded nanotube structures are recovered. The method of recovery varies based on the method used to load material into the interior volume, such as recovering a pellet from a centrifuge container or recovering loaded nanotube structures from the surface of a filter medium, and/or recovering loaded nanotube structures from a fluidized bed. Techniques for recovery in the different methods are consistent with those known in the art. For example, excess material can be decanted and the remaining volume cleaned, e.g., washed with deionized water (DI water), and so forth. The choice of wash liquid depends on the choice of polymer solution. For example, while PBS (buffer) is a good liquid to dissolve alginate, it will not readily dissolve chitosan, though both are polysaccharides and are polar materials. Selection of suitable pairs of liquids/gels is obvious to the polymer and materials community, based on open literature and expertise in the field.

Once recovered, the loaded nanotube structures can be further processed by, for example, polymerization, or other post loading treatments to encapsulate the loaded material within the nanotube structures. Other examples of encapsulation techniques include liposomes, core shell nanoparticles, hydrogels, gelation, and so forth. Once recovered and washed, the loaded nanotube structures can also be further processed for the intended application. Finally, the collected loaded nanotube structures are obtained.

A exemplary process of further processing loaded nanotubes provides loaded nanotube structures immobilized in an aligned or oriented configuration. In an embodiment, the method comprises subjecting loaded nanotube structures in a polymerizable medium to centrifugal force, electric field or magnetic field, thereby aligning and/or orienting the loaded nanotubes in a common configuration, and initiating polymerization of the medium. In one aspect, the loaded nanotubes are aligned by centrifugal force. As described elsewhere herein, nanotubes under centrifugal force will align with their axis roughly perpendicular to the axis of the centrifuge and parallel to the centrifugal force. In another aspect, the loaded nanotubes are oriented by exposure to an electric field or a magnetic field. Preferably, the nanotubes are loaded according to a method of the invention. In one embodiment, the polymerizable medium is different from the loading liquid used to load the nanotubes. In another embodiment, the polymerizable medium is the loading liquid used to load the nanotubes. Polymerization may be initiated by contacting the polymerizable medium with at least one of a polyerization catalyst, UV radiation and gamma ray radiation. The loaded nanotubes are thus immobilized in the aligned or oriented configuration.

The following examples are intended to be non-limiting and provide further details on aspects of the disclosed methods.

### EXAMPLE 1

### Centrifugation Assisted Loading

A carbon nanotube (10 microL) solution containing nanotube structures was added to a 1% alginate solution containing WGA 633 (wheat germ aggulutinin conjugated to Alexa Fluor® 633; Invitrogen Molecular Probes, Eugene, Oreg.). The alginate solution was placed in a centrifuge tube that was 4 mm in diameter and 5 cm long and had a volume of alginate solution of approximately 400 microL. After adding the nanotube solution, the tube was spun at 3220 G for 30 minutes. After centrifugation, approximately 300 microL of the alginate solution from the top of the centrifuge tube was removed and discarded, e.g., by decanting. The centrifuge tube was cut to facilitate the insertion of a pipette tip. Using a 200 microL pipette, the bottom portion of the solution containing alginate and nanotube structures was removed and transferred to a test tube containing 3.0 ml of deionized (DI) water. The centrifuge tube was rinsed with DI water several times to ensure complete removal of alginate and nanotube structures. The test tube containing alginate and nanotube structures was then vortexed for approximately 1 minute, and then 1 ml of 1M calcium chloride solution was added to crosslink the alginate contained within the interior of the nanotube structures. The test tube was vortexed during the crosslinking process (approximately 5 minutes).

### EXAMPLE 2

### Filtration Assisted Loading

An exemplary filtration assisted method involves suspending nanotubes in a solution and filtering the mixture through a nanoporous membrane. Continuous phase (liquid) would flow through the nanotube due to the pressure difference thus resulting in filling the nanotube. Tight control of the packing density of the nanotubes contributes to achieving significant loading.

### EXAMPLE 3

### Centrifugation Assisted Collection of Nanotube Structures

Nanotube structures were loaded and crosslinked according to the centrifugation assisted loading method of EXAMPLE 1, above. After the completion of crosslinking, the test tube was centrifuged at 2000 G for 5 minutes (20° C.). The supernatant liquid was collected and filtered through a 200 nm polyester membrane. The pellet at the bottom of the test tube was broken with the tip of a transfer pipette, vortexed in DI water and then filtered through a 200 nm polyester membrane to collect the nanotube structures on the filter membrane. The filter membranes removed from the filtering contained the collected nanotube structures and were then prepared for confocal imaging by placing the membrane containing nanotube structures on a glass slide, adding mounting medium and sealing with a glass cover slip.

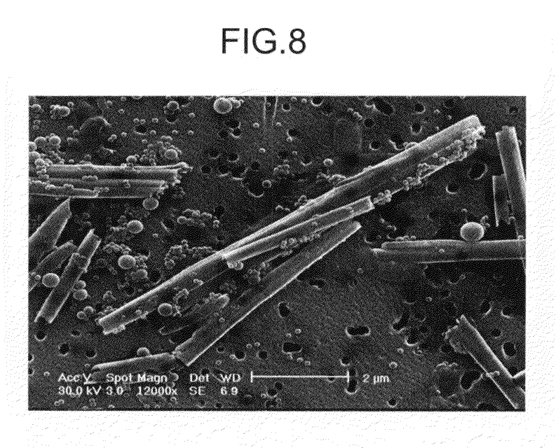

FIG. 8 is an image of collected nanotube structures on membranes according to this example; the material is from the pellet that resulted from centrifugation. The supernatant solution did not show any presence of nanotube structures. The image in FIG. 8 includes a membrane showing the nanotube structure with alginate. Other studies suggest that the nanotube structures are fully loaded with the alginate and that almost all of the nanotube structures are free of material on the outside, except a few that contained material at one region of the tube. Based on Example 1, it appears that removing free alginate from the nanotube structures by dilution results in no to minimal loss of material from the nanotube.

### EXAMPLE 4

### Filtration Assisted Collection of Loaded Nanotube Structures

A carbon nanotube (10 microL) solution containing nanotube structures was added to a 1% alginate solution containing WGA 633. The alginate solution was placed in a centrifuge tube that was 4 mm in diameter and 5 cm long and had a volume of alginate solution of approximately 400 microL. After adding the nanotube solution, the tube was spun at 3220 G for 30 minutes. After centrifugation, the solution was transferred to a vacuum filtration unit with 200 nm polyester membrane as the filter. Vacuum (pressure was not measured) was applied to remove the alginate, followed by addition of 1 ml of DI water twice. Vacuum was then stopped, and 1 ml of 300 mM calcium chloride solution was added to promote crosslinking. After 30 seconds, the vacuum was reapplied and the collected nanotube structures on the membrane washed a final time with DI water (3 ml). The filtered nanotubes were then prepared for confocal microscopy by placing the membrane containing nanotube structures on a glass slide, adding mounting medium and sealing with a glass cover slip.

In these studies with fluorescence in vacuum filtration methods, the fluorescence is observed to be present in the interior of the nanotube structures. The presence of fluorescence inside the nanotube structures indicates that the vacuum filtration method does not result in removal of filled alginate from the nanotube structures. Furthermore, since the loaded sodium alginate contained WGA 633, the fluorescence could only be due to the presence of alginate inside the nanotube structures.

The present application discloses methods and techniques to load a material into the interior of a nanotube structure. Once loaded, the loaded nanotube structures can be storage and/or delivery devices for the loaded contents. For example, loaded nanotube structures can have pharmacological, catalytic, sensory or other functions based on the loaded contents.

Although described in connection with preferred embodiments thereof, it will be appreciated by those skilled in the art that additions, deletions, modifications, and substitutions not specifically described may be made without department from the spirit and scope of the invention as defined in the appended claims.

What is claimed is:

1. A method of loading nanotube structures, the method comprising:
moving a loading solution through an interior region of a nanotube structure, wherein the loading solution includes a material to be loaded into the nanotube structure and wherein the material to be loaded is retained in at least a portion of the interior region of the nanotube structure as the loading solution is moved through the interior region;
removing excess of the loading solution from the loaded nanotube structure; and
collecting the suspended loaded nanotube structures.

2. The method of claim 1, wherein moving the loading solution is by moving the nanotube structure through a volume of the loading solution to flow the loading solution through an interior region of the nanotube structure, wherein the nanotube structure is moved by centrifugation, a magnetic field or an electric field.

3. The method of claim 2, wherein prior to centrifugation, an initial liquid containing suspended nanotube structures is placed on top of the loading solution.

4. The method of claim 1, where excess of the loading solution is removed from the loaded nanotubes by suspension of the loaded nanotube structures in a washing liquid.

5. The method of claim 4, comprising separating loaded nanotube structures from the loading solution by one of: a filtration process; and forming a mass and washing with excess washing liquid.

6. The method of claim 5, wherein the filtration process includes application of a positive or a negative pressure.

7. The method of claim 5, wherein forming the mass is by centrifugation.

8. The method of claim 1, wherein the loading solution has a density, at 25° C. and standard pressure, greater than or less than water.

9. The method of claim 1, wherein the loading solution has a viscosity, at 25° C. and standard pressure, greater than water.

10. A method of loading a polymerizable medium into a nanotube structure, the method comprising:
suspending nanotube structures in an initial suspension liquid;
placing the suspension of nanotube structures on top of a loading solution, the loading solution including a material to be loaded into the nanotube structure, wherein the loading solution comprises a crosslinkable or polymerizable polymer and can have a viscosity higher than the washing liquid;
centrifuging the suspension of nanotubes and the loading solution to move at least a portion of the nanotube structures from the initial suspension liquid into the loading solution;
recovering at least a portion of the nanotube structures from the loading solution;
transferring the recovered nanotube structures to a washing liquid and creating a suspension of the recovered nanotube structures;
adding a polymerization agent or crosslinking agent to the suspension to polymerize or crosslink the material loaded in an interior region of the nanotube structure; and
collecting the loaded nanotube structures.

11. The method of claim 10, wherein recovering at least a portion of the nanotube structures includes amassing at least a portion of the nanotube structures and removing an excess of the washing liquid.

12. The method of claim 10, wherein recovering at least a portion of the nanotube structures and/or collecting the loaded nanotube structures comprises a filtration process.

13. The method of claim 12, wherein the filtration process includes application of a positive or a negative pressure filtration and recovering nanotube structures loaded fully or partially with the loading solution.

14. The method of claim 10, wherein the initial suspension liquid further comprises the material to be loaded.

15. The method of claim 10, wherein the loading liquid has viscosity lower or higher than water at standard temperature and pressure.

16. The method of claim 10, wherein the crosslinking agent is low or high molecular weight material, UV radiation or gamma ray radiation, wherein the agent is capable of creating a network polymer structure of the crosslinkable or polymerizable polymer.

17. The method of claim 10, wherein the suspension of nanotube structures in initial suspension liquid is placed into a second liquid medium prior to placing the placing the suspension of nanotube structures on top of a loading solution.

18. The method of claim 17, wherein the initial suspension liquid has viscosity less than the second liquid medium and is miscible with the loading solution, the second liquid medium and the washing liquid.

19. The method of claim 17, wherein the second liquid medium is soluble in the loading solution and the washing liquid.

20. A method of loading nanotube structures comprising:
counterflowing a liquid to be loaded and the nanotube structure, wherein the liquid to be loaded travels in an opposite direction relative to the nanotube structures.

21. The method of claim 20, wherein counterflow includes both a translational and a rotational component.

22. The method of claim 21, comprising superimposing at least one of a high pressure and an elevated temperature on the counterflow.

23. The method of claim 22, wherein high pressure and high temperature are sufficient to create supercritical liquid conditions.

24. A method of orienting or and aligning loaded nanotubes in polymerizable medium, the method comprising:
aligning or orienting loaded nanotubes in a polymerizable medium by centrifugal force, electric field or magnetic field, wherein the polymerizable medium is a loading solution; and
initiating polymerization of the polymerizable medium,
wherein the loaded nanotubes are immobilized in an aligned or oriented orientation for a particular application.

25. The method of claim 24, wherein initiating polymerization comprises contacting the polymerizable medium with polymerization via a polymerization catalyst or UV or gamma ray radiation.
